(19) United States
(12) Patent Application Publication
(10) Pub. No.: US 2005/0238254 A1
(43) Pub. Date: Oct. 27, 2005

(54) Method and system for fast n-dimensional dynamic registration

(76) Inventors: Jens Guhring, Langensendelbach (DE); Sebastian Vogt, Princeton, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/109,104

(22) Filed: Apr. 19, 2005

Related U.S. Application Data
(60) Provisional application No. 60/564,902, filed on Apr. 23, 2004.

(51) Int. Cl. G06K 9/32; G06K 9/00

(52) U.S. Cl. 382/294; 382/128

(57) ABSTRACT

A method of updating the registration of a pair of images comprising the steps of providing a pair of images with a source image and a target image, determining a full registration between the source image and the target image, obtaining a first new target image, determining a registration between the target image and the first new target image, and determining an incremental registration between the first new target image and the source image, based on the registration between the first new target image and the target image and on the full registration between the source image and the target image. The determination of the full registration between the source image and the target image can be performed in parallel with the determination of the incremental registration between the first new target image and the source image.

### CROSS REFERENCE TO RELATED UNITED STATES APPLICATION

This application claims priority from “Fast n-D Dynamic Registration Scheme”, U.S. Provisional Application No. 60/564,902 of Guehring, et al., filed Apr. 23, 2004, the contents of which are incorporated herein by reference.

### TECHNICAL FIELD

This invention is directed to the dynamic registration of digital medical image datasets.

### DISCUSSION OF THE RELATED ART

Image registration is an optimization problem that finds a geometric transformation that maps points from a source dataset space into homologous points in a target dataset space. The objective of image registration is to describe a geometric mapping between two images with some kind of a model, which usually is dependent on parameters, known as registration parameters. The model determines the type of registration, whether it is a rigid, affine, deformable, registration, etc., and therefore the specifics of the registration parameters. N-D dynamic registration is defined as the registration between n-dimensional image datasets where at least one of them is changing over time (moving, deforming, etc.).

Image registration has been studied in various contexts due to its significance in a wide range of areas, including medical image fusion, remote sensing, recognition, tracking, mosaicing, and so on. Fast registration of dynamically changing datasets is an important aspect of a large range of applications including the analysis of dynamic processes (e.g. MR or CT perfusion imaging), image guided intervention, and augmented reality.

Registration can be characterized as either rigid or non-rigid. Rigid registration considers only rotation and translation of the whole image to make it fit to the image to it is to be registered. In the case of 2D images, there are three registration parameters: one for the rotation and two for translation. Non-rigid registration includes, apart from these rigid transformations, affine transformations and deformable transformations. In an extreme case each pixel of a first image can be mapped to a pixel of the second image, independently of the rest of the image. Non-rigid registration has to be specified more precisely when it comes to its actual implementation. Usually a deformation is modeled in a certain way and parameterized. One example is the so-called Free-Form Deformation—FFD. The parameters of this deformation model are the registration parameters.

In the areas of diagnosis, planning, evaluation of surgical and radio-therapeutical procedures, typically multiple single-modality, or multi-modality images are acquired in the clinical track of events. Since these images are complementary to each other, the integration of useful data from separate images is often desired. Registration, a first step in this integration process, aims to bring the multiple images involved into spatial alignment. In the past few years, a multitude of registration algorithms achieving interactive performance have been proposed. Real-time registration, however, is still a challenging problem and subject of current research.

### SUMMARY OF THE INVENTION

Exemplary embodiments of the invention as described herein generally include methods and systems for fast registration of time variant n-dimensional datasets using incremental updates within the domain of the time variant dataset(s) and correcting for error accumulation in parallel by using registrations between the domains of both datasets.

According to an aspect of the invention, there is provided a method of updating the registration of a pair of images comprising the steps of providing a pair of images with a source image and a target image, wherein each said image comprises a plurality of intensities corresponding to a domain of points in a D -dimensional space, determining a full registration between said source image and said target image, obtaining a first new target image, determining a registration between said target image and said first new target image, and determining an incremental registration between said first new target image and said source image, based on the registration between said first new target image and said target image and on said full registration between said source image and said target image.

According to a further aspect of the invention, the steps of obtaining a first new target image, determining a registration between said target image and said first new target image, and determining an incremental registration between said first new target image and said source image are repeated a plurality of times during said determination of the full registration between said source image and said target image.

According to a another aspect of the invention, the method further comprises, after the determination of the full registration between said source image and said target image, obtaining a another second new target image, determining a registration between said second new target image and said first new target image, and determining an incremental registration between said second new target image and said source image based on the registration between said second new target image and said first new target image and on said full registration between said source image and said target image.

According to a further aspect of the invention, the step of determining the full registration between said source image and said target image is performed in parallel with the step of determining a registration between said target image and said first new target image and the step of determining an incremental registration between said first new target image and said source image based on the registration between said first new target image and said target image and on said full registration between said target image and said source image.

According to a further aspect of the invention, the parallel steps are performed on physically distinct processors.

According to a further aspect of the invention, the parallel steps are performed on separate threads running on the same processor.

According to a further aspect of the invention, the source image and the target image are obtained from different imaging modalities.

According to a further aspect of the invention, the incremental registration between said first new target image and said source image is performed using an optical flow.

According to a further aspect of the invention, the incremental registration between said first new target image and said source image is performed using a first Kalman filter, and the full registration between said first new target image and said source image is performed using a second Kalman filter, wherein a different observation model is used for the incremental registration and the full registration.

In a further aspect of the invention, the full registration between said source image and said target image is performed periodically after a predetermined time difference.

In a further aspect of the invention, the full registration between said source image and said target image is performed after a predetermined number of incremental registrations of a new target image and said source image.

In a further aspect of the invention, the full registration between said source image and said target image is triggered by an event.

In a further aspect of the invention, the event includes at least one of a processor load, a user interaction, and an accumulated incremental error threshold.

According to another aspect of the invention, there is provided a program storage device readable by a computer, tangibly embodying a program of instructions executable by the computer to perform the method steps for updating the registration of a pair of images.

### BRIEF DESCRIPTION OF THE DRAWINGS

FIG. 1 depicts a flow chart of a registration method according to an embodiment of the invention.

FIG. 2 depicts one possible implementation of the different phases of a proposed registration scheme on a multi-processor CPU, according to an embodiment of the invention.

FIG. 3 depicts a one dimensional example of the effect of error accumulation during incremental registration and the correction by means of periodical full registration, according to an embodiment of the invention.

FIG. 4 is a block diagram of an exemplary computer system for implementing a dynamic registration scheme, according to an embodiment of the invention.

### DETAILED DESCRIPTION OF THE PREFERRED EMBODIMENTS

Exemplary embodiments of the invention as described herein generally include systems and methods for fast registration of time-varying n-dimensional datasets.

As used herein, the term “image” refers to multi-dimensional data composed of discrete image elements (e.g., pixels for 2-D images and voxels for 3-D images). The image may be, for example, a medical image of a subject collected by computer tomography, magnetic resonance imaging, ultrasound, or any other medical imaging system known to one of skill in the art. The image may also be provided from non-medical contexts, such as, for example, remote sensing systems, electron microscopy, etc. Although an image can be thought of as a function from R³ to R, the methods of the inventions are not limited to such images, and can be applied to images of any dimension, e.g. a 2-D picture or a 3-D volume. For a 2- or 3-dimensional image, the domain of the image is typically a 2- or 3-dimensional rectangular array, wherein each pixel or voxel can be addressed with reference to a set of 2 or 3 mutually orthogonal axes. The terms “digital” and “digitized” as used herein will refer to images or volumes, as appropriate, in a digital or digitized format acquired via a digital acquisition system or via conversion from an analog image.

A dynamic registration scheme according to an embodiment of the invention can provide fast updates of registration parameters using a simplified incremental computation while avoiding error accumulation in the incrementally computed registration parameters by periodically applying corrections derived through more sophisticated, hence more time consuming processing. Delays in the update computation can be avoided by performing relative and absolute registration calculations in parallel. A registration scheme according to an embodiment of the invention would be beneficial for applications where the registration between time variant datasets within one domain (i.e., either the source dataset or the target dataset) is computationally less expensive than the registration between the source and the target dataset. This would be the case where the source and target datasets are taken from different imaging modalities, while the time varying target datasets are of the same imaging modality, so that computing an intra-modal registration would be less time consuming than computing an inter-modal registration. There is, however, no requirement that the source and target datasets be from different imaging modalities, and in an embodiment of the invention, the source and target datasets are from the same imaging modality.

If possible one would prefer to perform a full registration between a source image S and target image T for each new target image Tₖ. Current registration methods can do this, but not in real-time. Thus, instead of performing a more time-consuming full registration for each new target image, the previous registration parameters between S and T can be updated incrementally as described below, which is faster and provides the desired real-time performance. However, the incremental method is prone to accumulating errors with each step. To avoid an erroneous drift-off of the registration parameters between S and T, a full registration between S and T is still needed at times. According to one embodiment of the invention, the incremental and full updates would be implemented on at least two processors which work independently in parallel on the same datasets S and T: one continuously calculating the more lengthy full registrations between the latest available images from both datasets, and the other one continuously calculating the fast incremental updates from simple registrations of subsequent images. This enables one to always have an up-to-date registration between S and T for each image of the time-variant dataset(s) from the second processor and to account for accumulating errors by obtaining a full registration result from the first processor whenever it finishes a more time-consuming full registration. The full update of the parameters need only be performed occasionally as compared to the incremental update. The full updates remove the errors that have accumulated during the iterative update steps. The full registration update can then be applied retrospectively to correct all of the current registration parameters (i.e. the full registration at time step tᵢ₋₁+sum of all incremental updates).

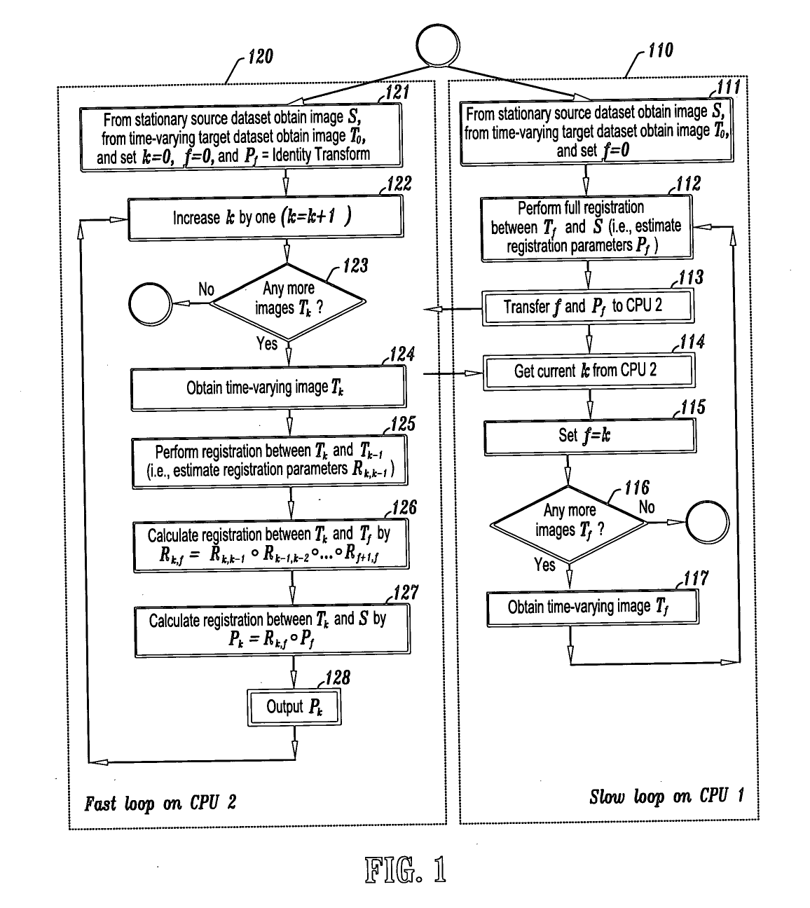

An n-dimensional dynamic registration method according to an embodiment of the invention is illustrated in the flow chart of FIG. 1. Instead of finding a geometric mapping between the source and target datasets every time with a more lengthy full registration method, a less time-consuming incremental intra-modal registration task between the subsequent images of the time variant dataset is performed. This intra-modal registration task is usually easier and faster since it only has to consider small geometrical deformations that happen in between the acquisition of the subsequent images within the same imaging modality. Referring now to the figure, a flow chart according to an embodiment that is implemented on two physically distinct processors is depicted, in which a slower registration 110 between the source and target dataset is performed on a first processor, and a faster, intra-modal registration 120 between subsequent target datasets is performed in parallel on a second processor. According to an embodiment of the invention, the two processors can share a common memory by which results of the two processes can be shared. In this embodiment, a synchronization mechanism, such as a semaphore or a lock can be used to ensure that the shared memory is accessed by one process at a time. This inter-process communication technique is exemplary and non-limiting, and other inter-process communication techniques are within the scope of the invention, such as having the slower loop interrupt the faster loop when a full registration is complete, or having the faster loop poll the slower loop to determine when the full registration is complete. According to another embodiment of the invention, each process can have its own, unshared memory, and data can be transferred from the memory of one process to the memory of the other process.

Referring again to the figure, the process 120 begins at step 121, where a source image S is obtained from a stationary dataset and a target image T₀ is obtained from a dataset that will vary in time. In addition, counters k and f are initialized to 0, and the full registration P_{f} between the source and the target is initialized to the identity transformation. Counter k serves as a time counter and labels the time varying target images, while counter f is used by the full registration process. At step 122, the incremental counter k is incremented by one, and at step 123 the process checks to see if there are any time varying images. If not, the process terminates, otherwise, at step 124, a new time varying image Tₖ is obtained. At step 125, the intra-modal registration parameters R_{k,k-1} between the previous target image Tₖ₋₁ and the current target image Tₖ are calculated. A variety of methods for performing these kinds of registration tasks are well known in the art. At step 126, the registration parameters R_{k,f} between the current target Tₖ and the target being processed by the full registration process, T_{f}, are calculated. The parameters R_{k,f} can be computed by taking the composition product of previous intra-modal registrations: R_{k,f}=R_{k,k-1}∘R_{k-1,k-2}∘ . . . ∘R_{f+1,f}, where the ‘∘’ operator indicates that the transformation is a geometrical mapping that takes Tf as its input, and maps its image elements onto the corresponding image locations in Tₖ. At step 127, the incremental registration between Tₖ and S can be computed by calculating Pₖ=R_{k,f}∘P_{f}. After the incremental registration is complete, the result Pₖ is output to the user or the application that runs this registration process and it is output to a memory shared by the two processes at step 128. This step is indicated by a thick line to indicate that it should be synchronized with the slower registration process 110: when process 110 is accessing the shared memory, process 120 must wait, and when process 110 is accessing the memory, process 120 is blocked from accessing the memory. The process returns to step 122 to check if more time varying images are available.

Thus, the registration parameters between source S and target T dataset are updated to reflect the changes that happened in T from T₀ to T₁. Similarly, the outcome of the registration between T₁ and T₂ can be used to “update” the registration parameters between source S and target T datasets again to have an up-to-date registration between S and T₂. This process of updating S is referred to as incremental updating since the registration between the fixed source S and moving target T dataset is kept incrementally up-to-date.

A full update of registration parameters for the source S and the most recent target Tₖ is computed in parallel with the incremental updates in process 110. Referring again to the figure, the process 110 begins at step 111, where a source image S is obtained from a stationary dataset and a target image T₀ is obtained from a dataset that will vary in time. In addition, counter f is initialized to 0. At step 112, a full registration between the most recently obtained target image T_{f} and source image S is computed. This set of full registration parameters can be denoted by P_{f}. At step 113, process outputs the current values of f and P_{f} to process 120, and obtains the current value of k from process 120 at step 114. These steps are indicated by thick lines to indicate that they must be synchronized with process 110, in a manner similar to step 128. According to an embodiment in which the processes share memory, the values of f and P_{f} would be written to that memory and the current value of k would be read from that memory. Next, the counter f is set to the value of the counter k at step 115. At step 116, the process checks if more time varying target images Tₖ are available, and if not, the process terminates. Otherwise, the process obtains another target image Tₖ and returned to step 112 to compute the next full registration. Note that by the time the full registration parameters have been computed, several intra-modal registrations may have been performed, and thus the most recently obtained target image my be several time iterations advanced from the previous target image upon which the full registration was performed.

The embodiments just described assume that the source image S is not changing over time and that the target image T is changing over time. According to another embodiment of the invention, incremental registration techniques can be applied if S is changing and T is not changing, or even when both are changing with time. The former case is essentially the same as the embodiments disclosed above, as only the labels S, T have been changed. In the latter case the incremental update of the registration parameters between S and T is computed from the outcome of the intra-modal registration between the subsequent images in S and the outcome of the intra-modal registration between the subsequent images in T.

The embodiments just described assumes the availability of more than one processor on which to perform the full and incremental updates. Multi-processor workstations that include two or more CPUs are common. On some computer systems, the graphics processor can also be used as a second processor. In addition, some recent CPUs are providing facilities for two or more independent processors to be incorporated into a single chip. However, according to another embodiment of the invention, in the absence of multiple physical processors, the incremental and full updates can be executed as independent threads or processes on a single CPU.

According to another embodiment of the invention, the full registration parameters are calculated periodically or quasi-periodically after a plurality of incremental registrations have been performed. There are several possibilities for determining when to perform the full update of the registration parameters. In one embodiment of the invention, the full update is performed periodically after a predefined time difference Δt. Alternatively, the full update can be preformed after a predetermined number of incremental registrations, or at the end of previous full registration computation. In another embodiment of the invention, the full update can be triggered by events, such as the CPU load, a user interaction, or quality measures, such as the accumulated error, computed during incremental registration, etc. This list of triggering events is non-limiting, and other events can serve to trigger a full update and still be within the scope of an embodiment of the invention.

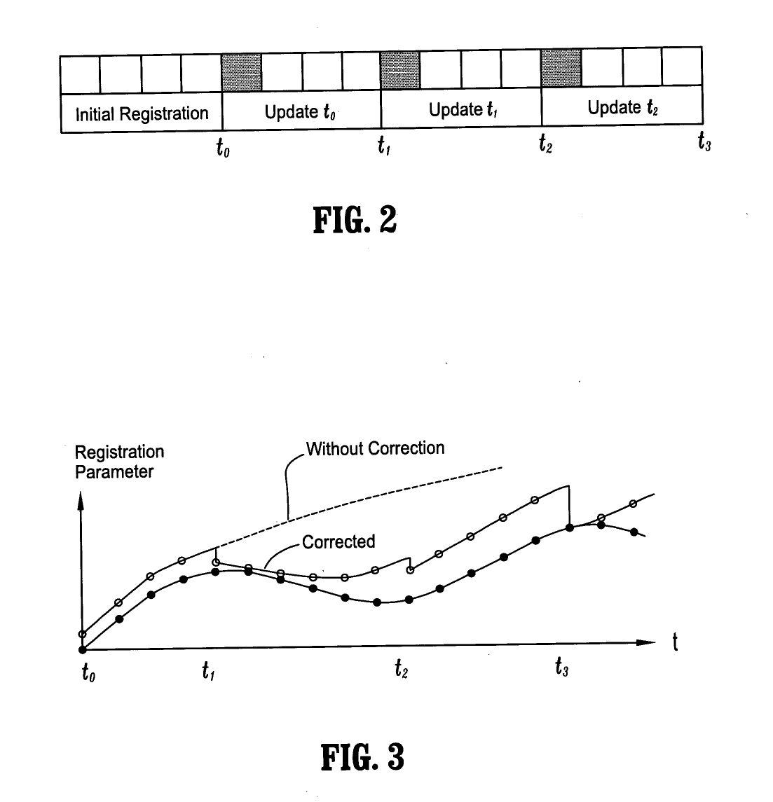

FIG. 2 illustrates one possible implementation of the different phases of the proposed registration scheme on a multi-processor workstation, according to an embodiment of the invention. The top row depicts the time frames for the incremental updates of the registration parameters, while the bottom row depicts the time frames for the full updates of the registration parameters. The gray boxes indicate when the results from the full registration have been applied to correct the incrementally computed registration parameters.

FIG. 3 illustrates a one dimensional example of the effect of error accumulation during incremental registration and the correction by means of periodical full registration. The graph in the figure depicts the time-evolution of an exemplary registration parameter. The lower curve, indicated by the solid dots, illustrates how the parameter's value would evolve if there were no error accumulation. The top curve, indicated by the circles, illustrates the time evolution of the parameter's value as incrementally updated, with full updates being applied at times t₁, t₂, and t₃. The graph illustrates how the upper curve begins to diverge from the lower curve between time t₀ and t₁, and the effect of the full update correction applied at time t₁. The dotted curve illustrates how the incrementally updated parameter value would evolve if no full update corrections were applied. The effects of the full update correction can be seen for the upper curve at times t₂ and t₃, where in each case the value in the upper curve is adjusted to more closely agree with the corresponding value on the lower curve.

According to another embodiment of the inventions, the incremental update can be performed using an n-dimensional Optical Flow technique. This technique calculates a displacement vector field between two images and relies on a brightness constraint, where corresponding image elements have the same brightness or color values. In a time-varying data set the brightness constraint is typically sufficiently fulfilled between two consecutive images. In this embodiment, the incremental updates are computed over that part of the image domain that contains time-varying data.

In another embodiment of the invention, a correspondence obtained through a one-to-one registration of the datasets within or across the modalities is used to update a state-space model, e.g. with a Kalman filter. A Kalman filter is useful for estimating and predicting the state of a system where the true values are hidden or unknown. A Kalman filter incorporates each new observation into a mathematical observation model that update the current “guess” of the system's registration parameters. In this embodiment, a set of parameters is provided that describe the current state of the system. The hidden system state is the current registration between the source image and the target image. Note that the target image changes with time, thus the system state is time-varying. The observation model can be different for the image correspondences obtained from the full registration between S and T and the image correspondences obtained from the incremental registrations between subsequent images of the time-varying dataset. In this scenario, the extracted correspondences would be considered as observations to compute corrected registration parameters. Kalman filter techniques can improve accuracy and stability by properly assimilating sequential observations.

One example application of an embodiment of the invention would be the non-rigid registration between real-time 4D ultrasound and pre-operation 3D CT or MRI data. 4D ultrasound is a time-sequence of 3D ultrasound volumes. Currently, ultrasound appears to be the only modality in which 3D volumes can be acquired in real time, thus ultrasound can be easily acquired during an intervention. However, 3D CT and MR images have a much superior image quality as compared to 3D ultrasound images. A setup combining ultrasound with CT or MR can potentially guide an interventional procedure by combining all pre-operation image and planning data with the ultrasound data acquired during the intervention. In this particular case the pre-operation dataset, such as the CT or MR dataset, would be static whereas the ultrasound data varies over time. Deformable inter-modality registration is computationally expensive. The tracking of small changes between subsequent ultrasound datasets can be done much more efficiently. This intra-modal registration problem can be solved for instance with 3D optical flow techniques. The result of these update computations can then be used to deform the pre-operation image data accordingly. To reduce the effect of error accumulation, the more time consuming registration between ultrasound and pre-operation datasets is computed in parallel. The result of this computation is then used to correct the registration parameters obtained from tracking the ultrasound datasets.

Although the embodiments of the invention have been described in terms of registration of images, it is to be understood that the techniques described herein have applicability to registration problems outside the context of registration of images. The underlying principles are general and not limited to the embodiments described herein, and can be applied to other data representations, such as implicit surfaces, meshes, point clouds, etc.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

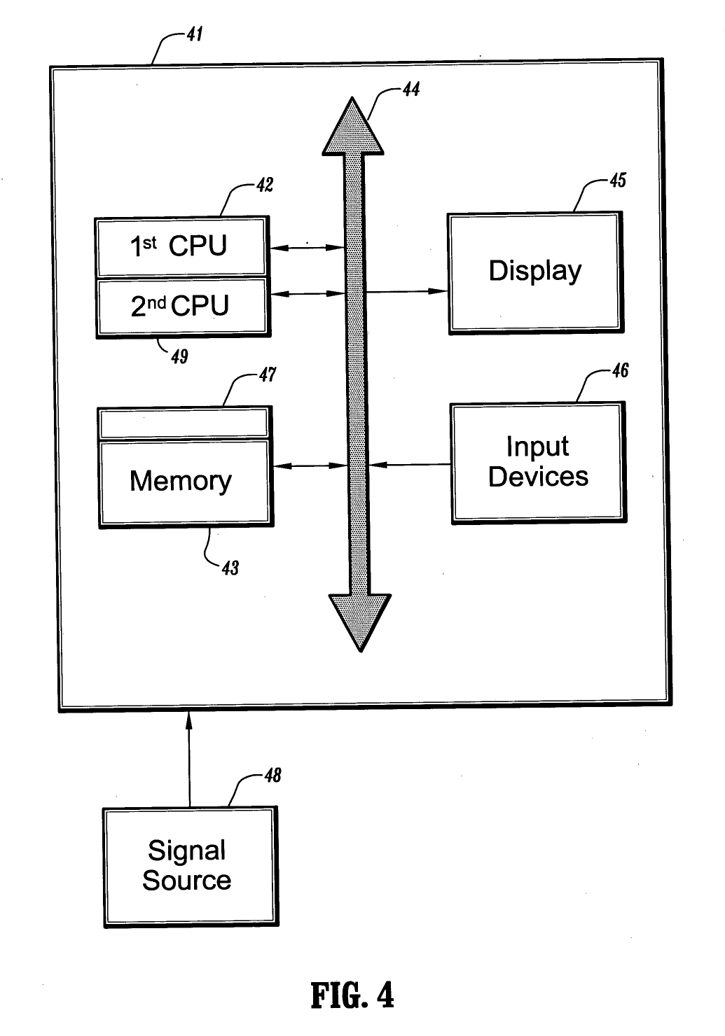

Referring now to FIG. 4, according to an embodiment of the present invention, a computer system 41 for implementing the present invention can comprise, inter alia, a first central processing unit (CPU) 42, a second processing unit 49, a memory 43 and an input/output (I/O) interface 44. The computer system 41 is generally coupled through the I/O interface 44 to a display 45 and various input devices 46 such as a mouse and a keyboard. The support circuits can include circuits such as cache, power supplies, clock circuits, and a communication bus. The memory 43 can include random access memory (RAM), read only memory (ROM), disk drive, tape drive, etc., or a combinations thereof. The present invention can be implemented as a routine 47 that is stored in memory 43 and executed by the CPU 42, and optionally by CPU 49, to process a signal from a signal source 48. As such, the computer system 41 is a general purpose computer system that becomes a specific purpose computer system when executing the routine 47 of the present invention.

The computer system 41 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method of updating the registration of a pair of images comprising the steps of:
providing a pair of images with a source image and a first target image, and a first full registration between said source image and said target image, wherein each said image comprises a plurality of intensities corresponding to a domain of points in a D-dimensional space;
determining a second full registration between said source image and said first target image;
obtaining a second target image;
determining a registration between said first target image and said second target image; and
determining an incremental registration between said second target image and said source image, based on the registration between said second target image and said first target image and on said first full registration between said first target image and said source image, wherein the step of determining the second full registration between said source image and said first target image is performed in parallel with the steps of obtaining a second target image, determining a registration between said first target image and said second target image, and determining an incremental registration between said second target image and said source image.

2. The method of claim 1, wherein the steps of obtaining a second target image, determining a registration between said second target image and said first target image, and determining an incremental registration between said second target image and said source image are repeated a plurality of times during said determination of the second full registration between said source image and said first target image.

3. The method of claim 1, wherein after the determination of the second full registration between said source image and said first target image, obtaining a third target image, determining a registration between said third target image and said first target image, and determining an incremental registration between said third target image and said source image based on the registration between said third target image and said first target image and on said second full registration between said source image and said first target image.

4. The method of claim 1, wherein the parallel steps are performed on physically distinct processors.

5. The method of claim 1, wherein the parallel steps are performed on separate threads running on the same processor.

6. The method of claim 1, wherein the source image and the target image are obtained from different imaging modalities.

7. The method of claim 1, wherein the incremental registration between said second target image and said source image is performed using an optical flow.

8. The method of claim 1, wherein the incremental registration between said second target image and said source image is performed using a first Kalman filter, and the full registration between said second target image and said source image is performed using a second Kalman filter, wherein a different observation model is used for the incremental registration and the full registration. .

9. The method of claim 1, wherein said full registration between said source image and a subsequent target image is performed periodically after a predetermined time difference.

10. The method of claim 1, wherein said full registration between said source image and a subsequent target image is performed after a predetermined number of incremental registrations of a previous target image and said source image.

11. The method of claim 1, wherein said full registration between said source image and a subsequent target image is triggered by an event.

12. The method of claim 11, wherein said event includes at least one of a processor load, a user interaction, and an accumulated incremental error threshold.

13. A program storage device readable by a computer, tangibly embodying a program of instructions executable by the computer to perform the method steps for updating the registration of a pair of images, said method comprising the steps of:
providing a pair of images with a source image and a first target image, and a first full registration between said source image and said target image, wherein each said image comprises a plurality of intensities corresponding to a domain of points in a D-dimensional space;
determining a second full registration between said source image and said first target image;
obtaining a second target image;
determining a registration between said first target image and said second target image; and
determining an incremental registration between said second target image and said source image, based on the registration between said second target image and said first target image and on said first full registration between said first target image and said source image, wherein the step of determining the second full registration between said source image and said first target image is performed in parallel with the steps of obtaining a second target image, determining a registration between said first target image and said second target image, and determining an incremental registration between said second target image and said source image.

14. The computer readable program storage device of claim 13, wherein the steps of obtaining a second target image, determining a registration between said second target image and said first target image, and determining an incremental registration between said second target image and said source image are repeated a plurality of times during said determination of the second full registration between said source image and said first target image.

15. The computer readable program storage device of claim 13, wherein after the determination of the second full registration between said source image and said first target image, obtaining a third target image, determining a registration between said third target image and said first target image, and determining an incremental registration between said third target image and said source image based on the registration between said third target image and said first target image and on said second full registration between said source image and said first target image.

16. The computer readable program storage device of claim 13, wherein the parallel steps are performed on physically distinct processors.

17. The computer readable program storage device of claim 13, wherein the parallel steps are performed on separate threads running on the same processor.

18. The computer readable program storage device of claim 13, wherein the source image and the target image are obtained from different imaging modalities.

19. The computer readable program storage device of claim 13, wherein the incremental registration between said second- target image and said source image is performed using an optical flow.

20. The computer readable program storage device of claim 13, wherein the incremental registration between said second target image and said source image is performed using a first Kalman filter, and the full registration between said second target image and said source image is performed using a second Kalman filter, wherein a different observation model is used for the incremental registration and the full registration.

21. The computer readable program storage device of claim 13, wherein said full registration between said source image and a subsequent target image is performed periodically after a predetermined time difference.

22. The computer readable program storage device of claim 13, wherein said full registration between said source image and a subsequent target image is performed after a predetermined number of incremental registrations of a previous target image and said source image.

23. The computer readable program storage device of claim 13, wherein said full registration between said source image and a subsequent target image is triggered by an event.

24. The computer readable program storage device of claim 23, wherein said event includes at least one of a processor load, a user interaction, and an accumulated incremental error threshold.

25. A method of registering a pair of time-varying images, said method comprising the steps of:
obtaining a source image and a target image, wherein each said image comprises a plurality of intensities corresponding to a domain of points in a D-dimensional space;
initializing a full registration between said source image and said target image;
obtaining a new target image;
determining a registration between said target image and said new target image;
determining an incremental registration between said new target image and said source image, based on the registration between said new target image and said target image and on said initial full registration between said source image and said target image;
determining a full registration between said source image and said target image,
wherein the steps of obtaining a new target image, determining a registration between said target image and said new target image, and determining an incremental registration are repeated until said full registration between said source image and said target image is completed; and
using said full registration between said source image and said target image to correct the incremental registration between said new target image and said source image.
